(19) United States
(12) Patent Application Publication
(10) Pub. No.: US 2017/0152758 A1
(43) Pub. Date: Jun. 1, 2017

(54) Locking Element for a Borescope Opening of a Gas Turbine

(71) Applicant: MTU Aero Engines AG, Muenchen (DE)

(72) Inventors: Petra KUFNER, Poing (DE); Markus SCHLEMMER, Mainburg / Sandelzhausen (DE); Walter GIEG, Eichenau (DE); Oliver THIELE, Dachau (DE); Inga MAHLE, Muenchen (DE)

(73) Assignee: MTU Aero Engines AG, Muenchen (DE)

(21) Appl. No.: 15/363,891

(22) Filed: Nov. 29, 2016

(30) Foreign Application Priority Data
Nov. 30, 2015 (DE) 10 2015 223 684.6

(51) Int. Cl. F01D 21/00

(52) U.S. Cl. CPC F01D 21/003; F05D 2220/32; F05D 2260/83; F05D 2260/30

(57) ABSTRACT

A locking element for a borescope opening of a gas turbine is disclosed. The borescope opening includes a radially inner opening edge facing a gas-carrying annular channel of the gas turbine where the locking element includes a main section and a locking section connected to the main section. The locking section is configured at least partially in a rotationally-symmetric manner with regard to a longitudinal axis of the locking element. The locking element is dimensioned such that the locking section protrudes partially over the radially inner opening edge of the borescope opening in the inserted state into the borescope opening.

This application claims the priority of German Patent Application No. 10 2015 223 684.6 filed Nov. 30, 2015. the disclosure of which is expressly incorporated by reference herein.

### BACKGROUND AND SUMMARY OF THE INVENTION

The present invention relates to a locking element for a borescope opening of a gas turbine, in particular an aircraft gas turbine, and the borescope opening includes a radially inner opening edge facing a gas-carrying annular channel of the gas turbine, and the locking clement includes a main section and a locking section connected to the main section, and the locking section is configured at least partially in a rotationally-symmetric manner with regard to a longitudinal axis of the locking element.

Indications of the direction such as “axial” or “radial” and “circumferential” must essentially be understood with regard to the machine axis of the gas turbine, insofar as nothing to the contrary emerges explicitly or implicitly from the context.

Locking elements of this type, which may also be designated as borescope plugs, are known. Such borescope plugs are generally screwed in via threads, and the rotationally-symmetric, generally spherical locking section ends tangentially with an inner contour of the annular channel. Owing to this arrangement of the locking element, which is lowered with its locking section virtually in the borescope opening or in the inner contour of the annular channel, large intermediate spaces result between the outer contour of the locking section and a wall delimiting the borescope opening which lead to disruptions of the hot gas flow.

The object of the invention is to further develop a locking element such that the above disadvantages may be reduced.

As a solution, it is provided to dimension the locking element such that the locking section protrudes partially over the radially inner opening edge of the borescope opening in the inserted state into the borescope opening.

It has been shown that the locking section protruding over the opening edge, i.e., into the annular channel, leads to the borescope opening being filled better by the locking section such that the dimensions of the disadvantageous intermediate spaces may be reduced. In this regard, it has surprisingly been found that the locking section protruding into the annular channel, in particular by way of the rotationally-symmetric design of the locking section has a less disruptive effect on the flow than the presence of larger intermediate spaces in the case of locking sections which end tangentially with the inner contour of the annular channel.

In order for such a locking element to be used independent of the installation angular position thereof with regard to the inner contour of the annular channel, it is preferred for the locking section to be configured spherically or conically or cone-shaped.

In this regard, the locking element may be dimensioned such that it seals the hot gas-carrying annular channel in cooperation with an opening wall adjoining the radially inner opening edge.

As a further development, it is provided for the maximum diameter of the locking section to substantially correspond to the inner diameter of the borescope opening formed by the opening wall. In the case of a spherically configured locking section, the maximum diameter of the locking section is equal to the diameter of the corresponding sphere. In the case of a conical or cone-shaped locking section, the maximum diameter of the locking section is the largest diameter which the cone or truncated cone comprises.

The main section preferably has a length which is dimensioned such that the locking section, defined in the dimensions thereof depending on the inner diameter of the borescope opening, protrudes over the radially inner opening edge.

The invention further relates to a gas turbine, in particular an aircraft gas turbine having at least one turbine stage and a hot gas-carrying annular channel assigned to the turbine stage and/or having at least one compressor stage and a gas-carrying annular channel assigned to the compressor stage, and the annular channel of the turbine stage and/or the compressor stage includes a radial outer wall, in which at least one borescope opening is provided, and the borescope opening includes an opening edge configured in the radial outer wall, to which an opening wall adjoins in a substantially radial direction, and a locking element is inserted in the borescope opening, the locking element includes a main section and a locking section, and the locking section is surrounded by the opening wall such that the hot gas-carrying annular channel is sealed, and in order to solve the above object it is provided that the locking section protrudes partially over the radially inner opening edge of the borescope opening in the inserted state into the borescope opening,

In this regard, the outer wall of the annular channel may be inclined at least in sections with regard to the axial direction of the gas turbine such that the outer wall substantially has the shape of the outside surface of a truncated cone. In this regard, it is pointed out that the outer wall of the annular channel is not straight or linearly shaped over the entire axial length thereof like the surface line in the case of a commonly defined cone, but rather the outside surface may also be configured slightly undulated.

To this end, as a further development it is provided for the locking section to protrude over an imaginary line in the annular channel with regard to the axial longitudinal section through the borescope opening, the imaginary line connecting an axially forward opening edge section of the opening edge and an axially rearward opening edge section of the opening edge along the outside surface inclined towards the axial direction. This imaginary connection line may also be understood as the line which formed a tangent to the locking section according to the prior art when the locking section was virtually lowered in the borescope opening or ended tangentially with an inner contour of the annular channel.

In order for the flow of hot gas through the locking section protruding into the annular channel to be only slightly disrupted, it is preferred for the locking section to protrude into the annular Channel in a distance measured orthogonally to the imaginary line, and the distance is approximately 2% to 30%, preferably 10% to 24%, at most preferably 14% to 18% of the diameter of the borescope opening measured in the axial direction. In other words, the distance of the protrusion into the annular channel should be no more than approximately 2% to 30% of the diameter of a spherical locking element, the outer diameter of which generally corresponds substantially to the inner diameter of the borescope opening.

In the preferred case that the locking section is configured spherically, a spherical segment of the locking section may protrude into the annular channel. In this regard, the height of the spherical segment may correspond to the orthogonally measured distance.

The invention is described below by way of example and in a non-limiting manner with reference to the attached Figures.

### BRIEF DESCRIPTION OF THE DRAWINGS

FIG. 1 is a schematic and simplified longitudinal sectional illustration of a cutout of a turbine stage of a gas turbine with the locking element for a borescope opening inserted therein; and

FIGS. 2A and 2B are two enlarged illustrations of the region designated with II in FIG. 1 and in FIG. 2A a locking section is also indicated in a known position and in FIG. 2B another position of the locking section is indicated.

### DETAILED DESCRIPTION OF THE DRAWINGS

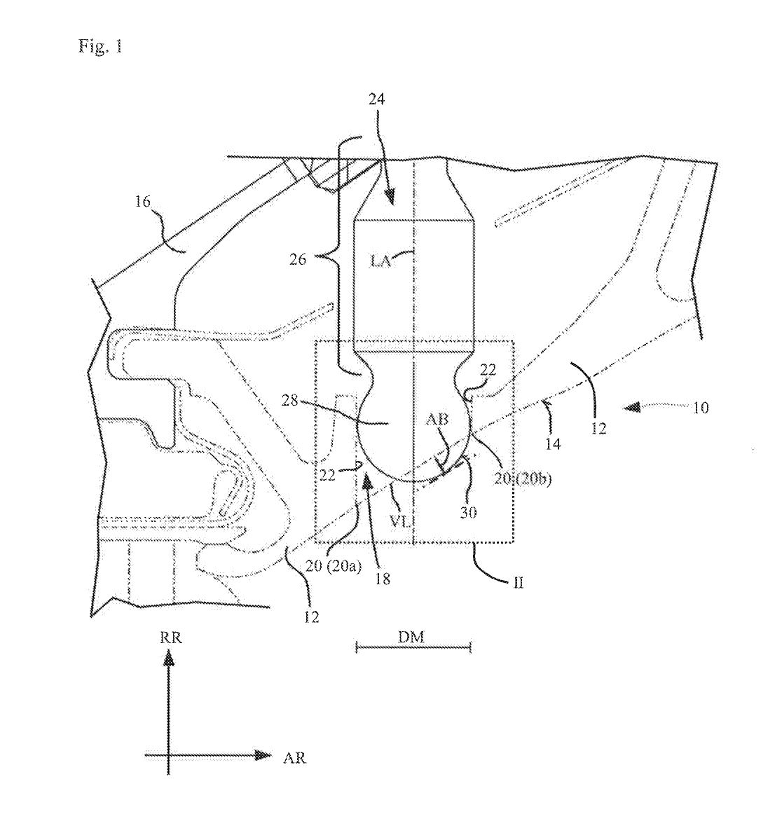

FIG. 1 shows a partial illustration of a hot gas-carrying annular channel 10 of a turbine stage, not designated further, of a gas turbine that is likewise not illustrated further. The axial direction with regard to the machine axis of the gas turbine is designated with AR and the radial direction is designated with RR.

The annular channel 10 is at least in sections delimited by an annular channel wall 12 with an inner side 14 facing the hot gas flow. The annular channel wall 12 is connected with further components of the turbine stage or the gas turbine not described further, in particular a housing component 16. In order to be able to inspect a turbine stage in question, in particular the rotor blades thereof, a borescope opening 18 is provided in the annular channel wall 12. Corresponding accesses, for example in the housing component 16 and in appropriate components of the gas turbine located further radially outside, are usually present such that a borescope may be inserted through these accesses and through the borescope opening 18 in the annular channel wall 12 and the turbine stage may be examined.

The annular channel 10 comprises a contour corresponding to the inner side 14, and the inner side 14 runs inclined towards the axial direction AR. The inner side 14 of the annular channel 10, broadly speaking, substantially comprises the shape of an outside surface of a cone, and as is visible from FIG. 1, the inner side 14 is not straight or linearly shaped over the entire axial length thereof, as is the surface line in the case of a normally defined cone. In other words, it may also be said that the annular channel expands in the radial direction RR along the axial direction AR, which substantially corresponds to the flow direction of hot gas. In this inclined inner side 14, which is usually also curved in the circumferential direction around the machine axis, the borescope opening 18 is recessed, and a radially inner opening edge 20 is configured as a transition between the borescope opening 18 and the inner side 14.

In the radial direction RR, an opening wall 22 of the borescope opening 18 adjoins the opening edge 20. This opening wall 22 is configured in the present example in the annular channel wall 12.

The borescope opening 18 is locked during the operation of the gas turbine by a locking element 24 which may also be designated as a borescope plug. The locking element 24 is substantially formed by a main section 26 and a locking section 28 which are connected to each other, in particular they are configured integrally with each other. The locking section 28 is usually configured in a rotationally-symmetrical manner around a rotation axis which corresponds in the present embodiment to the longitudinal axis LA of the locking element 24. In the example shown, the locking element 24 is inserted in the turbine stage or the gas turbine such that the longitudinal axis LA extends substantially parallel to the radial direction RR. However, other installation positions of the locking element 24 are also conceivable, in the case of which the longitudinal axis is inclined axially forward or axially rearward with regard to the radial direction RR. The longitudinal axis LA may also further deviate in the circumferential direction from the radial direction RR. By using a rotationally-symmetric locking element 24, in particular in the shape of a sphere or a cone, the same locking element may be used in different installation positions.

In the embodiment illustrated in FIG. 1, the locking section 28 is configured spherically. The locking element 24 is further designed such that it protrudes with the locking section 28 thereof into the annular channel 10 in the state inserted into the borescope opening 18 or partially penetrates into the annular channel. In the example illustrated, the locking section 28 protrudes over an imaginary line VL which (in the axial direction AR) connects the forward opening edge section 20a and the rearward opening edge section 20b to each other. In the sectional illustration of FIG. 1, this connection line VL may also be seen as an imaginary addition of the inner side 14 of the annular channel wall if no borescope opening 18 were provided. The connection line VL is also inclined towards the radial direction RR and towards the axial direction AR. The locking section 28 protrudes with its outer surface 30 by a distance AB, which is measured orthogonally towards the connection line VL, into the annular channel 10 such that the locking section protrudes over the radially inner opening edge 20 of the borescope opening 18. The locking section 28 comes into contact with the opening wall 22 in this position with its outer surface 30 such that sealing of the annular channel 10 of the turbine stage may be achieved.

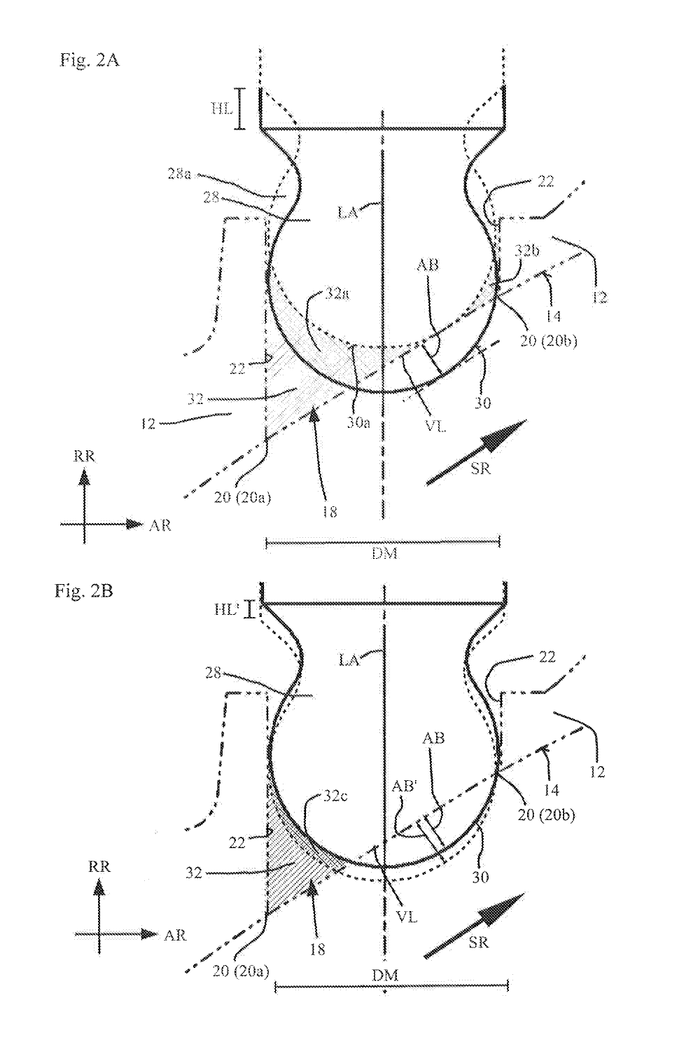

FIG. 2A shows an enlarged cutout corresponding to the dashed edged region H of FIG. 1. The locking section 28 is also illustrated in FIG. 2A in the inserted position thereof in the borescope opening 18. A locking section 28a is illustrated in a dashed manner, which is inserted in the borescope opening 18 in a position known from the prior art. In this regard, the locking section 28a ends with the inner side 14 or the contour of the annular channel 10 such that the connection line VL forms a tangent to the outer surface 30a of the locking section 28a. The locking section 28a is received in the borescope opening in a virtually lowered manner.

in the case of the position of the locking section 28 such that it protrudes into the annular channel 10, an intermediate space 32 (simply hatched surface) formed between the outer surface 30 and the opening wall 22 is reduced, compared to the known position of the locking section 28a illustrated in a dashed manner, in the case of which the intermediate space 32 is enlarged by the region 32a (cross-hatched surface) or a corresponding volume. An additional intermediate space 32b is also further formed in the case of the known arrangement of the locking section 28a on the rear side of the locking section 28a in the flow direction SR.

By reducing the intermediate space 32, disruptions of the hot gas flow, in particular vortexes in the intermediate space 32, may be prevented. Owing to the rotationally-symmetrical, preferably spherical design of the locking section 28, hot gas can flow through the part of the locking section protruding into the annular channel 10 with less resistance. The reduction of the intermediate space 32, in particular by the volumes in the regions 32a and 32b in combination with the protruding of the locking section 28 into the annular channel 10 leads to fewer disruptions of the flow of hot gas such that an improved operation and an improved degree of effectiveness of the turbine stage may be achieved as a whole.

It is further visible from FIG. 2A that an adaptation to the rotationally-symmetrical, in particular spherical, locking section 28 is not required for the modified position of the locking element 24 in the borescope opening 18, but rather the main section 26 is extended for example by an amount HL, compared to a known locking element. The extension HL of the main section 26 may be carried out at any position along the longitudinal axis LA. Accordingly, the present invention may also be implemented for already existing gas turbines by replacing existing shorter locking elements with new longer locking elements 24.

FIG. 2B shows another position of the locking section 28 in a dashed illustration such that it protrudes even somewhat more into the annular channel 10 (distance AB′), but still with the outer surface 30 thereof coming into contact with the axially rearward opening edge 20b of the borescope opening 18. As described above with reference to FIG. 2A, the main section 26 may in this case also be extended with respect to a main section 26 according to FIG. 1 or 2A by an amount HL′. The intermediate space 32 has become smaller by the region or the volume 32c (cross hatched), and the distance AB′ has become somewhat larger. The above reference numerals contained in FIG. 2B designate the same components as already described with reference to FIGS. 1 and 2A and are again contained in FIG. 2B, even though they are not described again.

The distance AB marked in FIGS. 1, 2A and 2B between the imaginary connection line and the outer surface 30 of the locking section is approximately 2% to 30% of the diameter DM of the borescope opening 18. In other words, the distance AB is approximately 2% to 30% of the diameter DM of the spherical locking section 28. Preferred large regions of the distance AB are approximately 10-24% and further preferably 14-18% of the diameter DM. The protrusion of the locking section 28 by the distance AB into the annular channel 10 may be selected in dependence on the alignment and geometry of the borescope opening and the contour of the annular channel 10 such that an overall less disrupted flow of hot gas may be achieved, and intermediate spaces 32, 32a, 32b between the locking section 28 and the opening wall 22 are minimized by enlarging the distance AB of the outer surface 30 from the connection line VL.

Overall the locking element 24 for a borescope opening 18 provides the possibility of improving the flow conditions in an annular channel 10 of a turbine stage, and contrary to previous teaching, a protrusion of the locking section into the annular channel is accepted as it leads to less disruption of the flow, in particular when using a spherical locking section.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

10 Annular channel

12 Annular channel wall

14 Inner side

16 Housing component

18 Borescope opening

20 Opening edge

20a Axially forward opening edge section

20b Axially rearward opening edge section

22 Opening wall

24 Locking element (borescope plug)

26 Main section

23 Locking section

30 Outer surface

32 Intermediate space

32a Enlargement intermediate space

32b Intermediate space

32c Reduction intermediate space

AB Distance

AR Axial direction

DM Diameter

HL Extension main section

LA Longitudinal axis

RR Radial direction

SR Flow direction

VL Connection line

What is claimed

1. A locking element for a borescope opening of a gas turbine, wherein the borescope opening includes a radially inner opening edge that faces a gas-carrying annular channel of the gas turbine, comprising:
a main section; and
a locking section connected to the main section, wherein the locking section is configured at least partially in a rotationally-symmetric manner with regard to a longitudinal axis of the locking element;
wherein the locking section protrudes partially over the radially inner opening edge of the borescope opening and into the gas-carrying annular channel when inserted into the borescope opening.

2. The locking element according to claim 1, wherein the locking section is spherical or conical or cone-shaped.

3. The locking element according to claim 1, wherein the locking section seals the gas-carrying annular channel in cooperation with an opening wall that adjoins the radially inner opening edge.

4. The locking element according to claim 3, wherein a diameter of the locking section substantially corresponds to an inner diameter of the borescope opening formed by the opening wall.

5. The locking element according to claim 4, wherein the main section has a length such that the locking section protrudes over the radially inner opening edge by an amount which corresponds to at least 2% of a maximum diameter of the locking section.

6. A gas turbine, comprising:
a gas-carrying annular channel, wherein the gas-carrying annular channel has a radial outer wall, wherein a borescope opening is included in the radial outer wall, wherein the borescope opening includes an opening edge in the radial outer wall, and wherein an opening wall adjoins the opening edge; and
a locking element, wherein the locking element is inserted in the borescope opening, wherein the locking element includes a main section and a locking section, wherein the locking section is surrounded by the opening wall such that the gas-carrying annular channel is sealed, and wherein the locking section protrudes partially over the opening edge of the borescope opening and into the gas-carrying annular channel.

7. The gas turbine according to claim 6, wherein the radial outer wall is inclined at least in sections with regard to an axial direction of the gas turbine such that the radial outer wall substantially has a shape of an outside surface of a truncated cone.

8. The gas turbine according to claim 7, wherein the locking section protrudes over a line into the gas-carrying annular channel, wherein the line connects an axially forward opening edge section of the opening edge and an axially rearward opening edge section of the opening edge, and wherein the line is inclined with respect to the axial direction of the gas turbine.

9. The gas turbine according to claim 8, wherein the locking section protrudes into the gas-carrying annular channel by a distance measured orthogonally to the line and wherein the distance is approximately 2% to 30% of an inner diameter of the borescope opening.

10. The gas turbine according to claim 9, wherein a spherical segment of the locking section protrudes into the gas-carrying annular channel.

11. The gas turbine according to claim 10, wherein a height of the spherical segment corresponds to the distance.
